(19) United States
(12) Patent Application Publication
(10) Pub. No.: US 2017/0128948 A1
(43) Pub. Date: May 11, 2017

(54) VIAL ATTACHMENT CLIP FOR PREVENTING HEMOLYSIS AND OTHER SPECIMEN CONTAMINATION ISSUES INVOLVED WITH ROLLING OF BLOOD RETAINING SPECIMEN TUBES

(71) Applicant: DUSTIN ANGER, Flint, MI (US)

(72) Inventor: DUSTIN ANGER, Flint, MI (US)

(21) Appl. No.: 14/933,905

(22) Filed: Nov. 5, 2015

(51) Int. Cl. B01L 9/06; A61J 1/16

(52) U.S. Cl. CPC B01L 9/06; A61J 1/16; B01L 2300/08; B01L 2300/123

(57) ABSTRACT

A flexible and twist-on clip for use with such as a blood vial or specimen tube. The clip includes a plasticized or other suitably constructed body defining an opening which reveals an inner perimeter sized to allow the clip to be twisted during application to the vial and so that the inner perimeter mates with and engages about a corresponding outer perimeter of the vial. Variants of the design may include an additional plurality of secondary apertures for providing additional elasticity to the clip body. Other variants can include outer configured protuberances to assist in exerting an anti-roll effect to the supported vial.

### CROSS-REFERENCE TO RELATED APPLICATIONS

Not applicable.

### FIELD OF THE INVENTION

The present invention discloses a flexible, twist on attachment body having an inner perimeter for use with a vial, such as containing a physiological (blood specimen). In particular, the attachment body or clip operates to prevent rolling of the blood filled vials and in order to prevent compromising of the integrity of the specimen.

### BACKGROUND OF THE INVENTION

During the collection of blood specimens there are several stages, the first stage is known as the “pre-analytic stage.” There can be a few reasons accounting for errors which can occur during this stage. The most prevalent of these is hemolysis of the specimen, and which often results in the inability to complete the requested tests for which the specimen was drawn.

In vitro hemolysis, defined as rupturing of the erythrocytes (red blood cells) and the release of their contents (cytoplasm) into the surrounding fluid (e.g. blood plasma), can be caused by improper technique during collection of blood specimens, by the effects of mechanical processing of blood, or by bacterial action in cultured blood specimens. By example, the concentration of potassium inside red blood cells is much higher than in the plasma and so an elevated potassium level is usually found in biochemistry tests of hemolyzed blood.

Most causes of in vitro hemolysis are related to specimen collection. Difficult collections, unsecure line connections, contamination, and incorrect needle size, as well as improper tube mixing and incorrectly filled tubes can also be causes of hemolysis. One particular instance results from rolling of the specimen tube following collection, during which the collision and rupturing the red blood cells significantly increases the hemolytic action within the plasma.

The rejection of specimens can be an expensive mistake. According to one study, 74% of errors recorded in pre-analytic stage are contributed directly to hemolysis. It has also been determined in studies that 43% of hemolysis is contributed to vigorously shaking or mixing of the specimen prior to completing the requested test.

Unrelated to hemolysis prevention other articles are known in the art for preventing roll off of such as thermometers, this is depicted by the Flinn Scientific Thermometer Anti-Roll-Off Device. One version of this device is provided in the form of a triangular shaped plug with a knurled outer perimeter and an enclosed circular inner perimeter sized to frictionally engage the outer perimeter of the glass thermometer from an inserting end.

### SUMMARY OF THE INVENTION

The present invention discloses a flexible and twist-on clip for use with such as a blood vial or specimen tube. The clip includes a plasticized or other suitably constructed body defining an opening which reveals an inner perimeter sized to allow the clip to be twisted during application to the vial and so that the inner perimeter mates with and engages about a corresponding outer perimeter of the vial.

Variants of the design may include an additional plurality of secondary apertures for providing additional elasticity to the clip body. Other variants can include outer configured protuberances to assist in exerting an anti-roll effect to the supported vial.

In use, the clip body is designed to clip over the specimen tube before the blood collection is attempted. Once blood is collected, it can be sat down on surfaces and remain secure. This will drastically cut back the movement of each specimen during the pre-analytic stage by decreasing the amount of rejected specimens due to hemolysis, thus producing a specimen which will yield more accurate test results from the pre-analytic stage to the analytic stage, positively affecting (i.e. lowering) the specimen rejection rate.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is an environmental view of a twist on clip for use with a blood collection specimen tube according to a first embodiment;

FIG. 2 is a perspective of the clip in FIG. 1 and better illustrating the open access configured within the triangular shaped body for twist applying the clip so as to receive the exterior perimeter of the specimen tube within the interior perimeter of the clip, along with the additional array of apertures defined in the material body for providing an additional degree of elasticity to the body;

FIG. 3 is a planar end view of clip and specimen tube in FIG. 1 and exhibiting the snug perimeter engagement established therebetween;

FIG. 4 is a top planar view of the clip of FIG. 1;

FIG. 5 is a bottom planar view of the clip of FIG. 1;

FIG. 6 is either a right or left planar side view of the clip of FIG. 1;

FIG. 7 is a perspective view of a slightly modified clip from that shown in FIG. 1 and illustrating a varied array of secondary apertures configured within the body;

FIG. 8 is a planar end view of clip in FIG. 7 and exhibiting the snug perimeter engagement established with a blood specimen tube or vial;

FIG. 9 is a top planar view of the clip of FIG. 7;

FIG. 10 is a bottom planar view of the clip of FIG. 7;

FIG. 11 is either a right or left planar side view of the clip of FIG. 7;

FIG. 12 is a perspective view of a further modified and generally circular/arcuate twist on clip according to a further embodiment and which includes outer configured protuberances to assist in exerting an anti-roll effect to the supported vial;

FIG. 13 is a planar end view of the clip of FIG. 12 and exhibiting the snug perimeter engagement established with a blood specimen tube or vial;

FIG. 14 is a top planar view of the clip of FIG. 12;

FIG. 15 is a bottom planar view of the clip of FIG. 12; and

FIG. 16 is either a right or left planar side view of the clip of FIG. 12.

### DETAILED DESCRIPTION OF THE PREFERRED EMBODIMENTS

Referring now to the attached illustrations, the present invention discloses a variety of twist-on anti-roll clip devices, such as can be used with any of a blood specimen vial, thermometer or pipette. As will be described, the present invention teaches a variety of clip devices which can be attached to an elongated and tubular fluid carrying vessel, again for the purposes of preventing the same from rolling upon a supported surface.

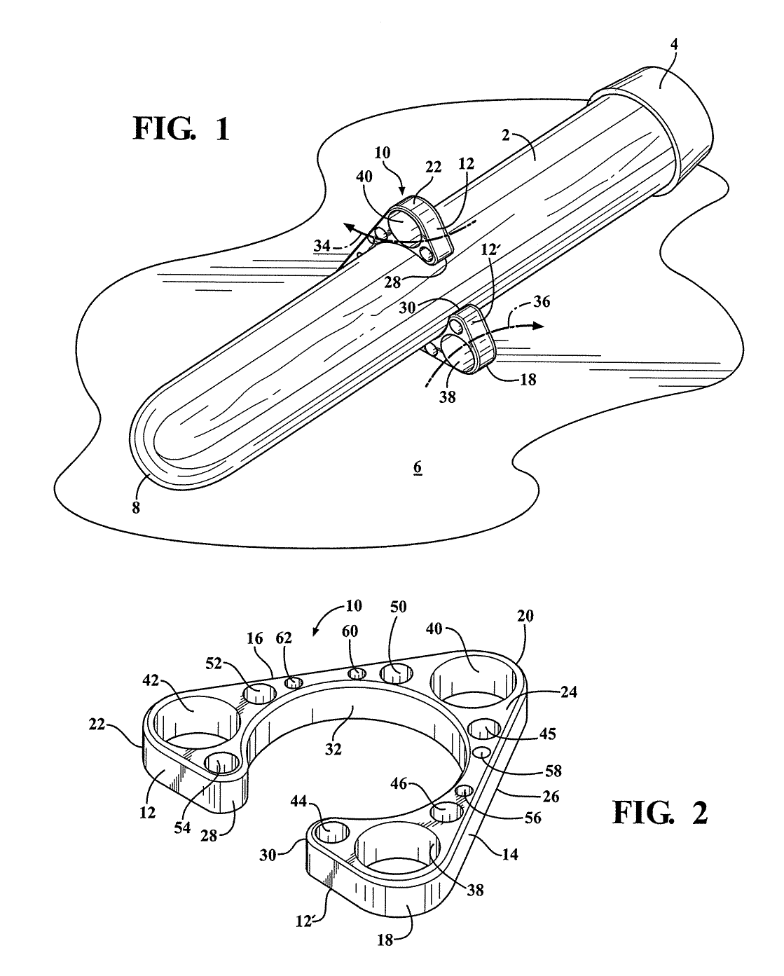

Referring initially to FIG. 1, an environmental view is provided of a twist on clip, generally at 10, for use with a blood collection specimen tube 2 according to a first embodiment. As previously described, a purpose of the clip is to prevent rolling of a cylindrical shaped specimen tube (or vial), such as in one instance to limit instances of contamination through hemolysis of a blood specimen contained within the vial. As further shown, a cap 4 (or other screw on, twist lock or other resistance fitting attachment such as a cork secure to the open end of the vial) is provided for hermetically sealing the vial interior once the specimen has been collected and deposited.

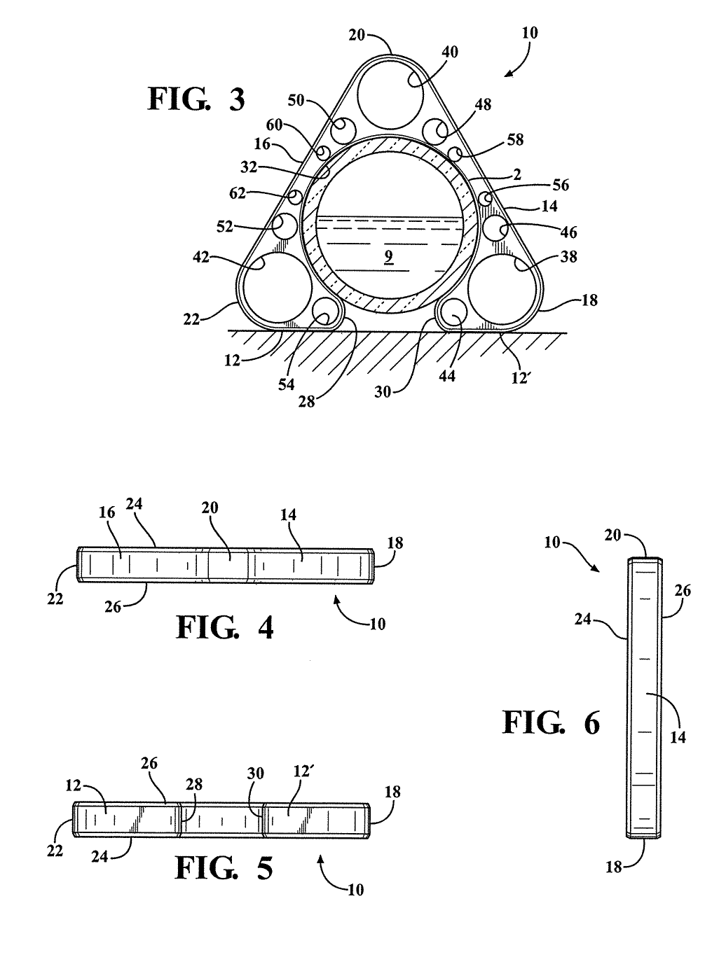

As further depicted in the successive perspective view of FIG. 2 and further plan views of FIGS. 3-6, the clip 10 depicted in the non-limiting embodiment exhibits a generally multi-sided configuration, in particular shown as a triangular shape with three sides 12, 14 and 16, such as further which can include rounded (as shown) or sharp interconnecting edges 18, 20 and 22. The clip 10 further exhibits flattened and spaced apart surfaces 24 and 26 which establish a given thickness therebetween for the body.

A pair of arcuate side wall locations 28 and 30 define a split in a selected side further depicted at 12 and 12′ and better illustrate an open access configured within the triangular shaped body for twist applying the clip 10 so as to receive the exterior cylindrical perimeter of the specimen tube 2 within a mating interior perimeter surface 32 of the clip in a friction fitting and mating arrangement. As further shown in FIG. 1, the spaced apart locations (sides 12/12′) of the triangular shaped clip body 10 can be deflected or twisted in the manner depicted by arrows 34 and 36 in order to resistively fit the clip over the vial 2 in the manner depicted so that the cap end 4 is angled upwardly from the surface 6 upon which the clip and the bottom closed end 8 of the vial are supported (the planar end view of FIG. 3 further depicting the internal blood 9 or other fluid specimen which is supported within the vial interior).

An additional array of apertures is further shown defined in the material body surrounding the inner perimeter surface 23, and for providing an additional degree of elasticity to the body. This includes, in the non-limiting embodiment shown, a largest plurality of apertures corresponding to the rounded corner locations 18, 20 and 22 and which are defined by interior closed perimeter surfaces 38, 40 and 42, respectively. Additional pluralities of apertures are depicted by intermediate secondary internal apertures (interior profile surfaces 44, 46, 48, 50, 52 and 54 which are distributed across the three interconnected sides) and additional tertiary (smallest) internal apertures 56, 58, 60 and 62.

The number, arrangement and configuration of the secondary interior apertures can be varied without limitation. It is also envisioned that other flex structure can be integrated into the plastic or plastic composite construction of the clip body (such further envisioning the use of foam or other material exhibiting a necessary degree of flex or bend)

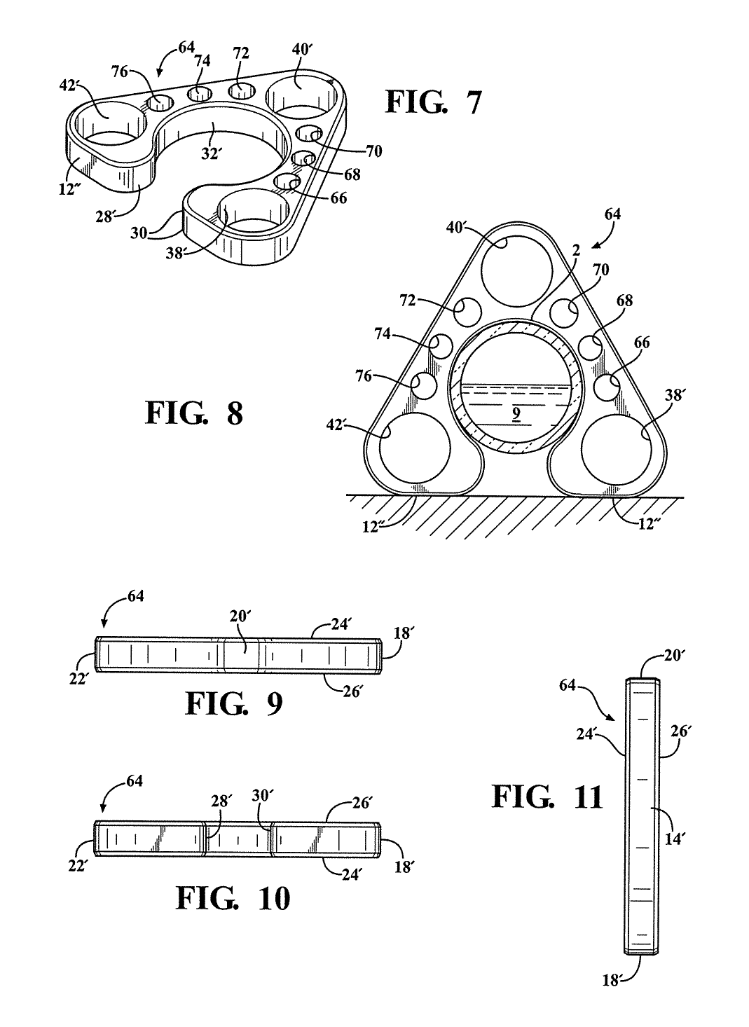

FIG. 7 is a perspective view of a slightly modified clip 64 from that shown in FIG. 1 at 10. A similar array of secondary internal apertures, see at 38′, 40′ and 42′, are shown (as in the clip 10 of FIG. 1), with a rearrangement of additional apertures depicted at 66, 68, 70, 72, 74 and 76. Otherwise, the clip 64 is generally similar in configuration and construction to that shown at 10 such that a repetitive description of the other features repeated from that variant is not necessary aside from referencing sides 12-16 and 12″, 14′ and 16′, corners as 18′, 20′, 22′, end faces 24′/26′, and walls 28′/30′ accessing inner perimeter 32′. Similar to FIG. 2, FIG. 8 is a planar end view of clip 64 in FIG. 7 and exhibiting the snug perimeter engagement established with a blood specimen tube or vial 2, with FIG. 9 a top planar view of the clip of FIG. 7, FIG. 10 a bottom planar view of the clip of FIG. 7 and FIG. 11 a right or left planar side view of the clip of FIG. 7.

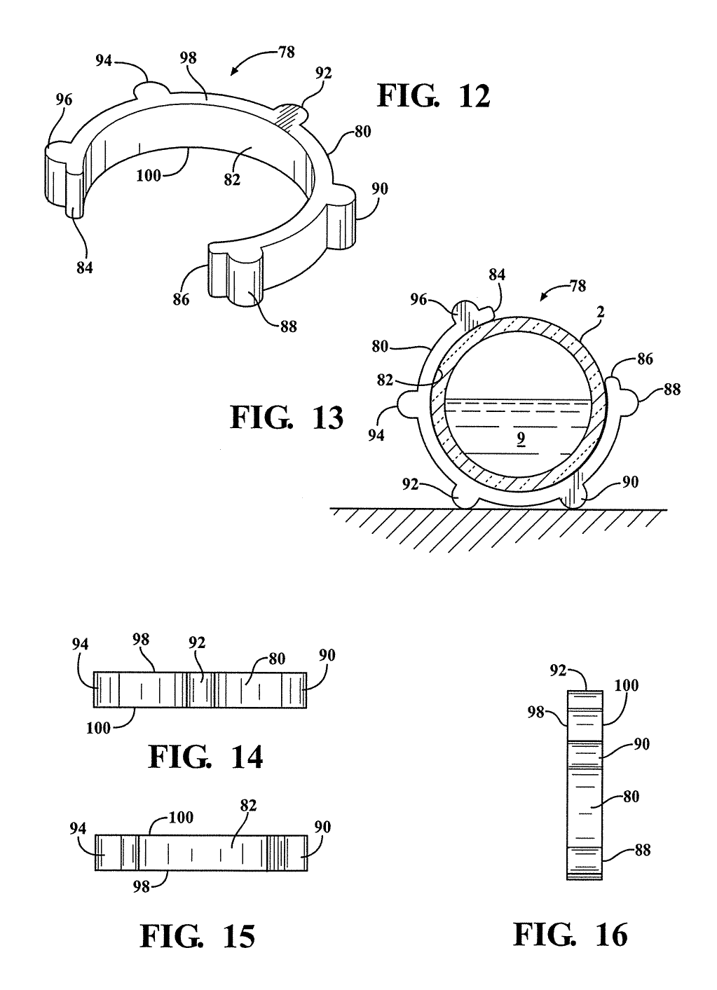

FIG. 12 is a perspective view of a further modified and generally circular/arcuate twist on clip 78 according to a further embodiment. As further shown, the clip 78 includes inner and outer spaced arcuate surfaces 80 and 82 with opposing spaced apart end 84 and 86. The clip 78 exhibits a circumferential perimeter some range greater than 180° (with the angular separation between the ends 84/86 likewise a corresponding value less than 180° totaling with the other value) 360°, this in order to biasingly engage the inner surface 82 against the exterior perimeter of the vial 2.

As further shown, a plurality of outer configured protuberances 88, 90, 92, 94 and 96 (shown as rounded bump shapes) are depicted projecting at circumferentially spaced apart locations along the clip body 78 and between first 98 and second 100 end faces, this to assist in exerting an anti-roll effect to the supported vial 2. The shape and configuration of the protuberances can likewise be modified within the scope of the invention to achieve an anti-roll effect for any desired construction of flexural/twist-on clip body.

FIG. 13 is a planar end view of the clip of FIG. 12 and again exhibits the snug perimeter engagement established with a blood specimen tube or vial 2. FIG. 14 is a top planar view of the clip of FIG. 12, FIG. 15 is a bottom planar view and FIG. 16 either a right or left planar side view of the clip 78.

Aside from reconfiguring the clip in a variety of different shapes and styles to effectuate twist-on application about the vial 2 exterior, it is envisioned that additional variants of the present inventions can contemplate providing any combination of clips and vials in a kit form. Other variants can include such as the addition of other coatings, materials or the like to the clip body, and in particular its inner defined gripping perimeter, in order to better secure the corresponding outer surface of the vial.

Having described my invention, other and additional preferred embodiments will become apparent to those skilled in the art to which it pertains, and without deviating from the scope of the appended claims.

I claim:

1-2. (canceled)

3. The clip as described in claim 6, further comprising a plurality of secondary apertures extending through said body for providing additional elasticity.

4. (canceled)

5. The clip as described in claim 6, said body further comprising a plastic or composite material.

6. An anti-roll clip for use with a specimen vial, the vial having circular outer perimeter, said clip comprising:
a body having a triangular shaped exterior profile with flattened spaced apart surfaces defining a thickness therebetween, a pair of spaced apart side wall locations defined in an outer edge wall of said body and revealing an opening in said body communicating with an inner perimeter extending surface which is sized to allow said opposing side wall locations of said body to be twisted relative to one another during application to the vial and so that the cross sectional profile of the vial is adapted to being inserted between said side wall location a duo releasing the side wall locations, seated within said inner perimeter so that said inner perimeter mates with and engages about the outer perimeter of the vial about an entirety of the inner perimeter of said opening up to said spaced apart side wall locations; and
upon being placed upon a level surface, the specimen vial adapted to being supported in an angled extending fashion from a first end to a second end.

7. An anti-roll clip for use with a specimen vial, comprising:
a body within which is defined an opening communicating with an inner perimeter surface sized to allow said body to be twisted during application to the vial and so that said inner perimeter mates with and engages about a corresponding outer perimeter of the vial; and
said body further having a substantially circular shape and having outer configured protuberances to assist in exerting an anti-roll effect to the supported vial, said outer configured protuberances projecting at circumferentially spaced apart locations along an exterior extending circular surface to prevent rolling of the vial upon the vial being placed upon a level surface, the specimen vial adapted to being supported in an angled extending fashion from a first end to a second end.

8. An anti-roll clip for use with a specimen vial, the vial having a circular outer perimeter, said clip comprising:
a body having a triangular shaped exterior profile with flattened spaced apart surfaces defining an edge wall thickness therebetween, a pair of spaced apart side wall locations configured within said edge wall revealing an opening in said body communicating with an inner perimeter extending surface and which is sized to allow said opposing side wall locations of said body to be twisted relative to one another during application to the vial and so that the cross sectional profile of the vial is adapted to being inserted between said side wall locations and, upon releasing the side wall locations, being seated within said inner perimeter so that said inner perimeter mates with and engages about the outer perimeter of the vial about an entirety of the inner perimeter of said opening up to said spaced apart side wall locations;
a secondary plurality of cushioning apertures extending through said wall thickness of said body between said edge wall and said inner perimeter; and
upon being placed upon a level surface, the specimen vial adapted to being supported in an angled extending fashion from a first end to a second end.

9. The anti-roll clip of claim 8, further comprising a tertiary plurality of cushioning apertures interspaced between said secondary apertures.

10. The anti-roll clip of claim 9, further comprising said secondary cushioning apertures being located proximate rounded edges of said triangular shaped body.

11. The anti-roll clip of claim 8, said body being constructed of a plastic or plastic composite material.
